(19) United States
(12) Patent Application Publication
(10) Pub. No.: US 2009/0217530 A1
(43) Pub. Date: Sep. 3, 2009

(54) METHOD FOR MOUNTING A SEAT PROVIDED WITH WEIGHT SENSORS ON A MOTORCAR FRAME

(75) Inventor: Leonardo Tiberi, Tolentino (IT)

Correspondence Address: OBLON, SPIVAK, MCCLELLAND MAIER & NEUSTADT, P.C., 1940 DUKE STREET, ALEXANDRIA, VA, 22314, US

(73) Assignee: Ferrari S.P.A., Modena (IT)

(21) Appl. No.: 12/095,815

(22) PCT Filed: Dec. 1, 2006
(86) PCT No.: PCT/IB06/03435

§ 371 Date: Nov. 11, 2008

(30) Foreign Application Priority Data
Dec. 2, 2005 (IT) BO2005A000736

(51) Int. Cl. B23P 11/00

(52) U.S. Cl. 29/897.2; 29/525.11

(57) ABSTRACT

A method for mounting a seat including weight sensors on a motorcar frame. The method includes the rigid connection to the motorcar frame of a number of weight sensors, each of which rests on a flat resting area of the motorcar frame and is rigidly connected to the motorcar frame by a number of bolts fastened in threaded holes obtained through the motorcar frame itself. The motorcar frame is completed by leaving the resting areas rough, and after completing the construction of the motorcar frame, each rough resting area is subjected to precision machining by a machine tool, which includes a flattening by milling and subsequently a drilling and a threading to make the holes.

### TECHNICAL FIELD

The present invention relates to a method for mounting a seat provided with weight sensors on a motorcar frame.

### BACKGROUND ART

A modern car is provided with a number of safety devices having the function of protecting the physical safety of the occupants in case of accident. One of the most widespread safety devices is the airbag, which comprises a flexible bag which is inflated extremely rapidly in case of collision (detected by accelerometric sensors) in virtue of a small explosive charge.

Some standards (e.g. standard US 208) contemplate that an airbag must not be activated when the seat is occupied by an infant; for this reason, it is necessary to recognise with extreme certainty whether a seat protected by an airbag is occupied by a child/adult or whether it is occupied by an infant. This indication may be provided in different ways, among which the most widespread is the presence of a switch which deactivates the intervention of the airbag which is controlled by means of a lock operated by the ignition key of the vehicle.

However, such method is not deemed fully reliable (and is expressly forbidden for example by standard US 208), because it is based on the correctness of actions of the driver who must provide to manually deactivate/reactivate the intervention of the airbag. For such reason, alternative solutions have been suggested, among which it is recalled using proximity sensors to assess the “dimensions” of the passenger on the seat, using radiofrequency recognition systems (transponders or the like) to determine the presence of a cradle (which must be provided with a transponder or the like), or using weight sensors to determine the weight of the passenger on the seat.

For example U.S. Pat. No. 6,366,200 describes a system adapted to detect the weight of a passenger occupying a seat by means of weight sensors to determine if the seat is empty, if the seat is occupied by an infant, or if the seat is occupied by an adult; specifically, the seat is considered empty if the weight detected by the weight sensors is lower than a first threshold value, the seat is considered occupied by an adult if the weight detected by the weight sensors is greater than a second threshold value, and the seat is considered occupied by an infant if the weight detected by the weight sensors is comprised between the first threshold value and the second threshold value.

In the currently marketed airbags the internal pressure and the inflated volume of the bag are constant and determined beforehand; it has recently been proposed a new generation of airbags (called “smart airbags”), which may be controlled to choke the inflation of the bag and therefore to obtain a variable internal pressure and/or volume of the bag. Specifically, the volume and/or the internal pressure of the inflated bag are varied according to the weight of the occupant of the seat, so as to adapt the features of the bag to the morphological features of the occupant of the seat. An example of a “smart airbag” is provided by U.S. Pat. No. 6,532,408.

From the description above, it is apparent that an assembly system of a seat provided with a measuring device of the occupant's weight is required.

By way of example, documents U.S. Pat. No. 6,039,344, WO0100454 and EP142624 describe an assembly system with measurement of the occupant's weight for a motorcar seat, wherein the seat is slidingly mounted on a sliding guide, which is in turn supported by a supporting frame mounted in floating manner on the motorcar frame by means of the interposing of four weight sensors.

The assembly systems with measurement of the occupant's weight known and described above present the drawback of requiring a high constructive precision (i.e. very low constructive tolerances) of the motorcar frame at the seat attachments in order to guarantee the correct operation. However, when the motorcar frame is made by joining several metallic extrusions by means of welding or riveting, the motorcar frame itself normally presents tolerances not compatible with the tolerances required for the correct operation of the weight sensors. Alternatively, a motorcar frame made by joining several metallic extrusions may have the necessary precision only by using extremely costly machining, assembly and inspection equipment; furthermore, operating with the tolerances required by the weight sensors would imply a high percentage of frame rejects with a further increase of costs.

Alternatively, it has been proposed to mount the sliding guide of the seat on an upper support frame, which is in turn mounted in floating manner by means of the interposition of four weight sensors on a lower supporting frame which is rigidly connected to the motorcar frame. The lower supporting frame is rigidly connected to the chassis of the motorcar by means of a plurality of bolts, which are inserted in through holes in the lower supporting frame and which are fastened in corresponding threaded holes made in the motorcar frame; the through holes of the lower supporting frame are made so as to allow a recovery of the constructive tolerances of the motorcar frame. In this way, the weight sensors are not mounted on the motorcar frame which presents a constructive tolerance in the order of 4-5 mm, but are mounted on the lower supporting frame which presents constructive and assembly tolerances in the order of 1-2 mm. However, the use of the lower supporting frame increases the total weight of the seat and generally leads the motorcar frame to inevitable stresses/deformations at the fixing points with the lower supporting frame itself.

### DISCLOSURE OF INVENTION

It is the object of the present invention to provide a method for mounting a seat provided with weight sensors on a motorcar frame, which method is easy and cost-effective to implement and which is, at the same time, free from the drawbacks described above.

According to the present invention, a method is provided for mounting a seat provided with weight sensors on a motorcar frame according to what is recited in the accompanying claims.

### BRIEF DESCRIPTION OF THE DRAWINGS

The present invention will now be described with reference to the accompanying drawings which illustrate some non-limitative examples of embodiment thereof, in which:

FIG. 1 schematically shows an exploded perspective view of an assembly system with measurement of the occupant's weight for a seat of a motorcar with parts removed for clarity;

FIG. 2 shows a portion of a motorcar frame in section and with parts removed for clarity;

FIG. 3 shows a further portion of a motorcar frame in section and with parts removed for clarity;

FIG. 4 shows a detail of the frame in FIGS. 2 and 3 in section and with parts removed for clarity.

### BEST MODE FOR CARRYING OUT THE INVENTION

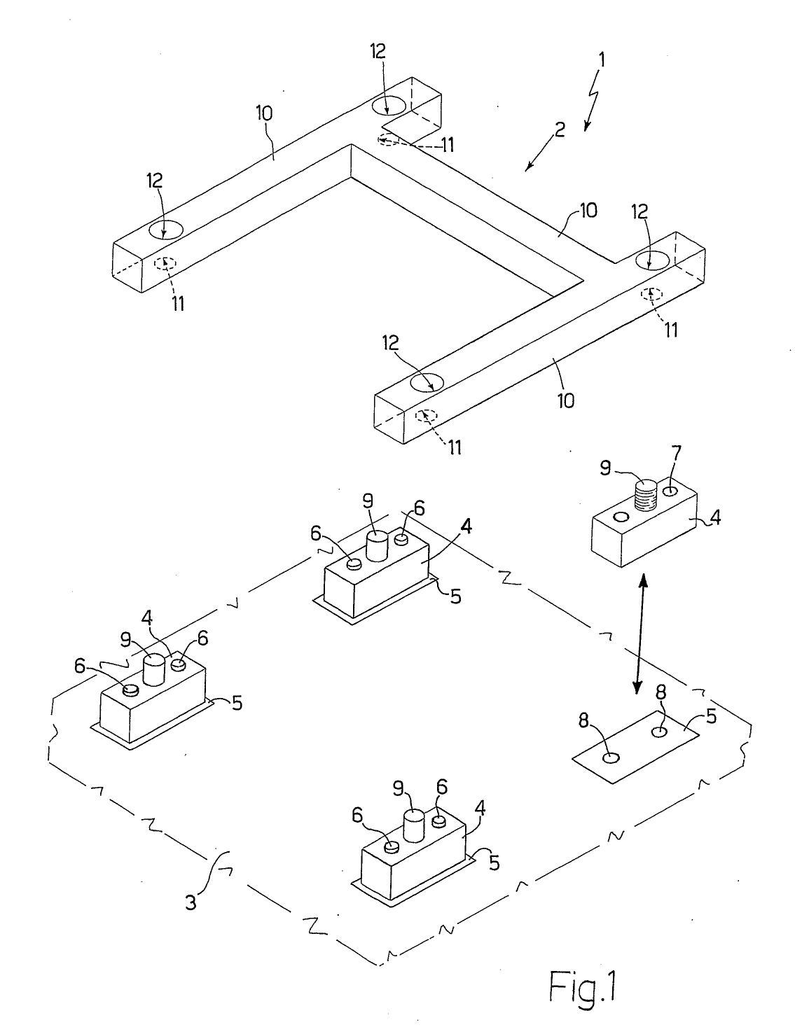

In FIG. 1, numeral 1 indicates an assembly system with measurement of the occupant's weight for a seat (not shown) of a motorcar.

Assembly system 1 comprises a supporting frame 2 carrying the seat and mounted in a floating manner on a frame 3 of the motorcar by means of the interposition of four weight sensors 4, each of which is rigidly connected both to supporting frame 2, and to frame 3. Each weight sensor 4 rests on a flat resting area 5 of frame 3 and is rigidly connected to frame 3 by means of a pair of bolts 6; each bolt 6 is arranged through a through hole 7 of weight sensor 4 and is fastened within a blank threaded hole 8 obtained through frame 3.

Each weight sensor 4 presents a bolt 9, which is vertically arranged in central position, is integrated in weight sensor 4, and is used to connect weight sensor 4 itself to supporting frame 2 by means of a respective nut (not shown). It is important to underline that bolt 9 is considered integrated in weight sensor 4, both when bolt 9 is permanently connected to weight sensor 4 itself (e.g. by means of welding or by co-moulding), and when bolt 9 is fastened into a specific threaded hole of weight sensor 4 itself.

Supporting frame 2 consists of the union (typically by means of welding) of three metallic profiles 10 having a boxed section. At each weight sensor 4, supporting frame 2 presents a lower through hole 11 through a lower wall of supporting frame 2 and is adapted to receive bolt 9 integrated in weight sensor 4. At each weight sensor 4, supporting frame 2 further presents an upper hole 12, which is over and coaxial to lower hole 11 and has a dimension so as to allow the passage of the corresponding nut and of a tool for fastening the nut itself.

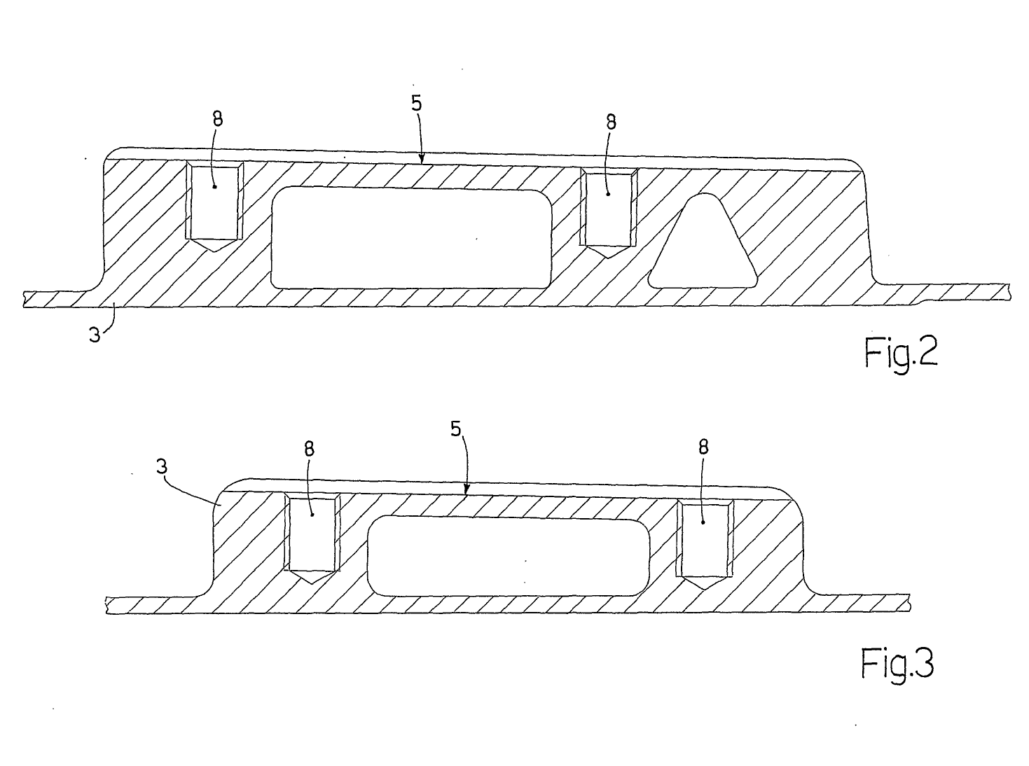

As better shown in FIGS. 2 and 3, frame 3 is solid, i.e. presents a relatively high full thickness, at the fastenings of screws 6 on resting areas 5 so as to allow the drilling and threading to obtain holes 8. Instead, outside resting areas 5 frame 3 has a boxed section so as to contain the total weight of frame 3 and to facilitate the welding and/or the riveting of the components of frame 3 itself.

In the components of frame 3, resting areas 5 are left rough and are subjected to a precise machining by means of a machine tool only once the assembly of frame 3 of is completed. Specifically, once the assembly of frame 3 is completed, each resting area 5 is flattened by milling and then at each resting area 5 two holes 8 are made by drilling and subsequent threading. In this way, all the inaccuracies related to the assembly of frame 3 may be compensated; so each resting area 5 presents the required tolerances both in relation to planarity, and in relation to parallelism, and each hole 8 presents the required tolerances both in relation to position, and in relation to perpendicularity.

In other words, by machining frame 3 after the completion of frame 3 is it possible to cancel out all the constructive errors of frame 3 itself; consequently, the only constructive errors of resting areas 5 and of holes 8 are introduced by the more precise machining by means of the machine tool.

It is important to note that each resting area 5 displays machining allowance, i.e. displays a greater thickness with respect to the required final thickness, so as to be able to machine resting area 5 by removal of material (typically by milling).

Experimental tests have shown that by operating as illustrated above, resting areas 5 and holes 8 present the required tolerances of 1-2 mm also if frame 3 as a whole presents tolerances of 4-5 mm. Furthermore, the fact of working resting areas 5 only after completing the assembly of frame 3 is simple and cost-effective to implement in the working cycle of frame 3 itself.

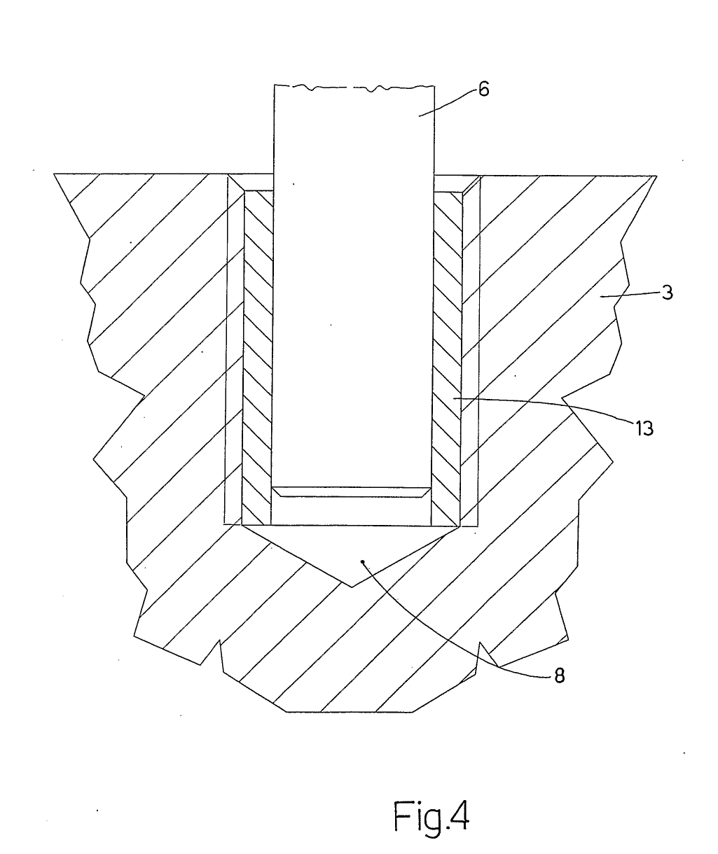

According to a preferred embodiment shown in FIG. 4, when frame 3 is formed by aluminium, then within each hole 8 a tubular steel insert 13, which is both external and internally threaded, is fastened; in this way, each tubular insert 13 is externally fastened with hole 8 and internally fastened with bolt 6. The function of tubular inserts 13 is to involve a greater strength section of aluminium frame 3 in the tightening of bolts 6 to increase the fastening force of weight sensors 4 to frame 3; in this way, weight sensors 4 are capable of more easily withstanding the pulling loads of the seat belt in case of accident. By way of example, tubular insert 13 may have an external diameter of 12 mm and bolt 6 may have an external diameter of 8 mm.

1-7. (canceled)

8. A method of mounting a seat including weight sensors on a motorcar frame, the method comprising:
rigidly connecting to the motorcar frame a number of weight sensors, each of which rests on a flat resting area of the motorcar frame and is rigidly connected to the motorcar frame by a number of first bolts fastened in first threaded holes obtained through the motorcar frame itself;
rigidly connecting to the weight sensors a supporting frame carrying the seat, so that the supporting frame appears mounted in floating manner on the motorcar frame by interposition of the weight sensors;
making the motorcar frame essentially solid and with machining allowance at the resting areas;
completing making of the motorcar frame leaving the resting areas rough; and
precision machining each rough resting area, after completing the making of the motorcar frame, by a machine tool by a flattening by milling and then a drilling and threading to make the first threaded holes.

9. A method according to claim 8, wherein each first bolt is arranged through a second through hole of the weight sensor and is fastened within a first blank threaded hole obtained through the motorcar frame.

10. A method according to claim 8, wherein each weight sensor presents a second bolt, which is vertically arranged in central position, is integrated in the weight sensor, and is used to connect the weight sensor itself to the supporting frame by a respective nut.

11. A method according to claim 8, wherein the motorcar frame is boxed outside the resting areas.

12. A method according to claim 8, further comprising fastening within each first threaded hole a tubular insert, which is both externally and internally threaded.

13. A method according to claim 12, wherein the frame is formed by aluminium and the tubular inserts are formed by steel.

14. A method according to claim 8, wherein the making of the frame of the motorcar comprises joining by welding and/or riveting a plurality of boxed extrusions.
